(19) United States
(12) Patent Application Publication
(10) Pub. No.: US 2007/0050685 A1
(43) Pub. Date: Mar. 1, 2007

(54) METHOD OF RESETTING AN UNRESPONSIVE SYSTEM AND SYSTEM CAPABLE OF RECOVERING FROM AN UNRESPONSIVE CONDITION

(76) Inventor: Chung-Hung Tsai, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/161,948

(22) Filed: Aug. 23, 2005

(51) Int. Cl. G06F 11/00

(52) U.S. Cl. 714/48

(57) ABSTRACT

A method of resetting an unresponsive system includes monitoring the system to detect when the system is in an unresponsive condition; receiving a predetermined code from a user interface; and resetting the system from the unresponsive condition after receiving the predetermined code from the user interface. In this way, a user of the system remains in control of resetting the system even when the system is otherwise unresponsive. For example, the user will notice that the system is not working properly and will perform a predetermined action on the user interface to thereby manually reset the system and regain control.

### BACKGROUND

The invention generally relates to electronic systems, and more particularly, to recovering from an unresponsive system.

Conventionally, a function for resetting a system is adopted to detect an occurrence of a runaway program in order to increase the reliability of a system containing a processing unit. A watch dog timer is normally used for this purpose. A watch dog timer function is used to detect an unexpected halt of a computer or processing unit arising from a bug of a program or from any other cause. Watch dog timers are particularly useful where the computer or processing unit is of the type that must not stop such as an industrial computer or a controller for controlling a machine.

The watch dog timer function can be integrated within a central processing unit (CPU) of an electronic system to detect when the CPU has stopped processing data. Alternatively, external watch dog timer circuits are also available to monitor CPU operations. In either case, the watch dog timer typically sets a value on a preset timer for a time period which corresponds to a time-out from a runaway program, and acts to implement a normal timer clearance within the range of the set value by a CPU instruction. In the case where the program is functioning normally under set conditions of this type, before a time-out is detected by the watch dog timer, the watch dog timer is cleared by the CPU so that the system is considered to be operating normally.

As opposed to this, in the case where a timer clearance for the watch dog timer has not been executed by a CPU instruction, for example as caused by an abnormality such as a runaway program or the like, the watch dog timer which has not been cleared overflows from the time-out. Specifically, an overflow signal is generated by the watch dog timer corresponding to an abnormal operation such as the runaway program, and the overflow signal is transmitted to the CPU and other external devices. Ideally, a non-maskable interrupt (NMI) process or the like is carried out, so that the system is finally returned to a normal operational state. However, in the situation that the CPU is totally unresponsive even to interrupts, there is typically only one available option and that is to reset the system using this overflow signal from the watch dog timer device.

However, when a consumer electronic product such as a digital television (DTV) receiver, a digital versatile/video disc (DVD) player or recorder, personal digital assistant (PDA), or cellular phone stops functioning and then automatically restarts after a timeout according to the overflow signal from a watch dog timer, this behavior of the electronic device can be alarming or even annoying to a user. Most users do not expect that such consumer electronic devices will automatically shutdown and restart on their own. However, they also don't expect that the device will “freeze” in a hang condition. An improved method of dealing with an unresponsive system would be beneficial.

### SUMMARY

Methods of resetting an unresponsive system and systems capable of recovering from an unresponsive condition are provided. An exemplary embodiment of a method of resetting an unresponsive system comprises: monitoring the system to detect when the system is in an unresponsive condition; receiving a predetermined code from a user interface; and resetting the system from the unresponsive condition after receiving the predetermined code from the user interface.

An exemplary embodiment of a system capable of recovering from an unresponsive condition comprises a watch dog timer for monitoring the system to detect when the system is in the unresponsive condition; a user interface receiver for receiving a predetermined code from a user interface; and a reset controller being coupled to the user interface receiver and the watch dog timer for resetting the system from the unresponsive condition after receiving the predetermined code from the user interface.

Another exemplary embodiment of a method of resetting a system, the method comprises: receiving a user interface interrupt from a user interface; enabling a counter to begin incrementing a timer value; and if the timer value has exceeded a predetermined value and a user interface code of the user interface interrupt corresponds to a predetermined code, asserting a reset signal to reset the system.

### BRIEF DESCRIPTION OF THE DRAWINGS

FIG. 1 shows a block diagram of a system being capable of recovering from an unresponsive condition according to an exemplary embodiment.

FIG. 2 shows a flowchart describing a method of resetting an unresponsive system according to a first exemplary embodiment.

FIG. 3 shows a flowchart describing a method of resetting an unresponsive system according to a second exemplary embodiment.

FIG. 4 shows a flowchart describing a method of resetting an unresponsive system according to a third exemplary embodiment.

FIG. 5 shows generalized method of resetting an unresponsive system according to a fourth exemplary embodiment.

### DETAILED DESCRIPTION

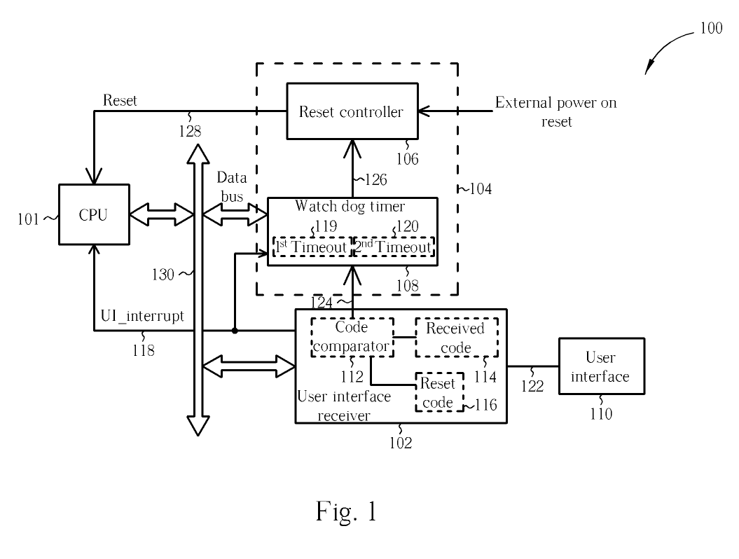

FIG. 1 shows a block diagram of a system 100 being capable of recovering from an unresponsive condition according to an exemplary embodiment. For example, the system 100 could be an audio or video storage, recovery, processing, playback, or display device such a digital versatile disc (DVD) player or digital television (DTV) receiver. Alternatively, in other embodiments, the system 100 is a portable electronic device such as a personal digital assistant (PDA), a cellular phone, or a notebook computer. The above example systems are not meant to be limiting, and in fact the present invention can be employed in any electronic system having a processing device and some kind of a user interface. As shown in FIG. 1, the system 100 includes a central processing unit (CPU) 101, a user interface receiver 102, a reset unit 104, and a user interface 110. The CPU 101 is coupled to the reset unit 104 and the user interface receiver 102 via a data bus 130. In this embodiment, the reset unit 104 further includes a reset controller 106 and a watch dog timer 108.

In a first embodiment, during normal operations, the CPU periodically resets the watch dog timer 108 using the data bus 130. After being reset, the watch dog timer 108 uses an internal timer to measure the time before being reset again by the CPU 101. A user of the system 100 controls the system 100 using the user interface 110. For example, the user interface 110 could be an infrared (IR) remote control, a touch panel, or other devices such as a set of user buttons or a keypad. In these embodiments, the connection 122 between the user interface could be implemented as an radio frequency (RF) signal, a direct electrical signal, an optical signal, or other signaling methods such as audio based sonar etc. Additionally, in another embodiment, the user interface 110, could also be a network device coupled to the system through a network 122. Codes sent from the user interface 110 are received by the user interface receiver 102. The user interface receiver 102 then interrupts the CPU 101 using the UI_interrupt 118 to inform the CPU 101 that a new code has been received from the user interface 110. Next, an interrupt service routine on the CPU 101 retrieves the received code from the user interface receiver 102 via the data bus 130 and clears the UI_interrupt line 118 so that a next code can be received.

In the event of an error condition such as a runaway program on the CPU 101, the timer of the watchdog timer 108 will reach a predetermined maximum value, and the watch dog timer 108 will therefore determine the CPU 101 to be executing a runaway program. In this state, the CPU 101 will be unresponsive to additional user commands and may appear to be frozen, locked or generally unresponsive to the user of the system 100. Because the user of the system 100 will not expect the system to immediately restart when becoming unresponsive, after determining the system 101 to be in an unresponsive state, the watch dog timer 108 waits for a predetermined code to be received by the user interface receiver 102. For example, the predetermined code could correspond to pressing the power off button or a reset button on the user interface 110 by the user of the system 100. Once the predetermined code has been received, the user interface receiver 102 outputs a signal 124 to the watch dog timer, and because the watch dog time 108 has already determined the CPU 101 to be in an unresponsive state, the watch dog timer 108 then outputs a signal 126 to the reset controller 106 to perform a system-wide reset. In this way, the user still remains in control of resetting the system 100 even when the system 100 is otherwise unresponsive. For example, for portable electronic devices or audio visual devices this means the user will notice that the device is not working properly (i.e., unresponsive or locked in a particular state) and the user will instinctively press the power button, for example, to thereby manually reset the system 100 and regain control.

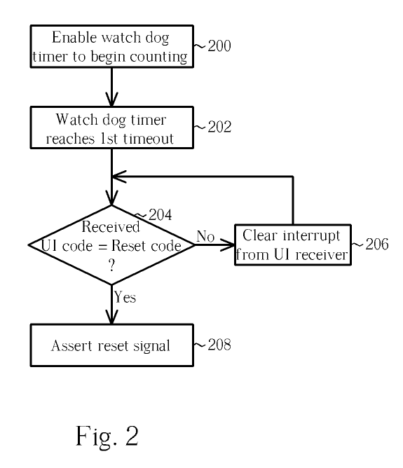

FIG. 2 shows a flowchart describing a method of resetting an unresponsive system according to a first exemplary embodiment. Provided that substantially the same result is achieved, the steps of the flowchart of FIG. 2 need not be in the exact order shown and need not be contiguous, that is, other steps can be intermediate. In this embodiment, resetting an unresponsive system includes the following steps:

Step 200: Enable a watch dog timer 108 to begin counting upwards. The watch dog timer 108 is periodically reset back to zero by a CPU 101 during normal operations.

Step 202: If the CPU 101 becomes unresponsive for some reason, the watch dog timer will reach a first predetermined timeout value (e.g., 1^{st} timeout 119). Once the first predetermined timeout value 119 has been reached, the watch dog timer 108 determines the system 100 to be in an unresponsive condition.

Step 204: Does a received user interface code equal a predetermined reset code? For example, if the predetermined reset code corresponds to the power button being pressed on the user interface 110, was the code corresponding to the power button received by user interface receiver 102. If yes, proceed to step 208; otherwise, proceed to step 206.

Step 206: Clear the interrupt from the user interface receiver 102 so that a next code can be received. For example, in FIG. 1, the UI_interrupt 102 will not be automatically cleared by the CPU 101 because the CPU 101 is no longer responding to interrupts. Therefore, during this step, the user interface receiver 102 will not only clear the UI_interrupt and previously received code but also recover itself to enable a next code to be received from the user interface 110.

Step 208: After the predetermined reset code is received, the reset unit 104 asserts the reset signal 128 to restart the CPU 101 and typically the entire system 100. In this way, the user is able to recover control from the unresponsive condition of the system 100 by performing a predetermined action at the user interface 110. Alternatively, in another embodiment, resetting the system 100 in step 208 involves actually powering off of the system 100.

At step 204, a comparison is performed to determined if a received user interface code is equal to a predetermined reset code. Referring to FIG. 1, in this exemplary embodiment, the user interface receiver 102 further includes a code comparator 112, a received code storage unit 114, and a predetermined reset code storage unit 116. Codes being received from the user interface 110 are stored in the received code storage unit 114, and with each new received code, the code comparator 112 compares the codes being stored in the received code storage unit 114 and the predetermined reset code storage unit 116. In this embodiment, if the two codes are the same, the code comparator 112 determines that the predetermined reset code has been received and asserts the signal 124 to the watchdog timer 108.

Concerning step 204, it should also be noted that other embodiments are also possible. For example, the predetermined reset code may correspond to other actions by the user at the user interface 110. For instance, in another embodiment, the predetermined reset code may be defined as receiving a predetermined number of concurrent codes corresponding to the user pressing the power button (or another button) on the user interface 110. This embodiment is useful for infrared wireless remote controllers that will repetitively send the same code or will send a repeat code when a user holds down a button on the remote control. When operating in this embodiment, if the user finds that the system is unresponsive, the user can hold down a button on the remote control such as the power button. The code comparator 112 will count the number of concurrent times that the codes stored in the received code storage unit 114 and the predetermined reset code storage unit 116 are the same. After the predetermined number of concurrent codes are received at the user interface receiver 102, control will proceed to from step 204 to step 208 in FIG. 2. Alternatively, in another embodiment, the predetermined reset code may be defined as a minimum time that the user needs to hold down a particular button on the user interface 110, or of a particular sequence of buttons to press. As will be apparent to those of ordinary skill, other embodiments having different predetermined reset codes are also possible.

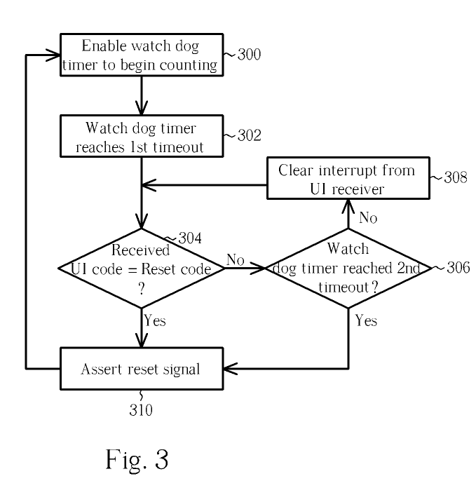

FIG. 3 shows a flowchart describing a method of resetting an unresponsive system according to a second exemplary embodiment. Provided that substantially the same result is achieved, the steps of the flowchart of FIG. 3 need not be in the exact order shown and need not be contiguous, that is, other steps can be intermediate. In this embodiment, resetting an unresponsive system includes the following steps:

Step 300: Enable a watch dog timer 108 to begin counting upwards. The watch dog timer 108 is periodically reset back to zero by a CPU 101 during normal operations.

Step 302: If the CPU 101 becomes unresponsive for some reason, the watch dog timer 108 will reach a first predetermined timeout value (e.g., 1^{st} timeout 119).

Step 304: Does a received user interface code equal a predetermined reset code? For example, if the predetermined reset code corresponds to the power button being pressed on the user interface 110, was the code corresponding to the power button received by user interface receiver 102. If yes, proceed to step 310; otherwise, proceed to step 306.

Step 306: Has the watch dog timer 108 reached a second predetermined timeout value (e.g., 2^{nd} timeout 120)? If the user does not manually reset the system from the user interface 110 after the system becomes unresponsive, the watch dog timer 108 will eventually reach the second predetermined timeout value and control will proceed to step 310. If the second predetermined timeout value has not yet been reached, proceed to step 308.

Step 308: Clear the interrupt from the user interface receiver 102 so that a next code can be received. For example, in FIG. 1, the UI_interrupt 108 will not be automatically cleared by the CPU 101 because the CPU 101 is no longer responding to interrupts. Therefore, during this step, the user interface receiver 102 will not only clear the UI_interrupt and previously received code but also recover itself to enable a next code to be received from the user interface 110.

Step 310: After the predetermined reset code is received at step 304 or after the watch dog timer 108 has reached the second timeout value 120, the reset unit 104 asserts the reset signal 128 to restart the CPU 101 and typically the entire system 100. In this way, the user is able to recover from the unresponsive condition by performing a predetermined action at the user interface 110, and if the user is not available to manually restart the system 100, the system 100 will automatically recover from the unresponsive condition.

When operating with the embodiment shown in FIG. 3, the watch dog timer 108 will eventually reset the system 100 if the system stays unresponsive long enough for the watch dog timer 108 to reach the second timeout value 120. This is useful for systems 100 that may be left alone by the user such as a DVD recorder being set for automatic recording operations. The user may have already stopped paying attention to the system 100 and will therefore be unavailable to manually reset the system 100 in the event of a runaway program or other system error causing an unresponsive condition.

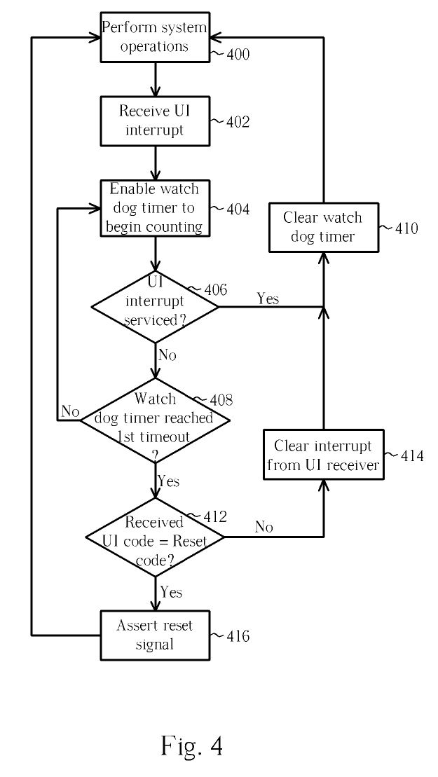

FIG. 4 shows a flowchart describing a method of resetting an unresponsive system 100 according to a third exemplary embodiment. In order to more accurately determine whether the CPU 101 is responding to user commands, in this embodiment, the watch dog timer 108 directly monitors the amount of time needed by the CPU 101 to process the interrupt service routine caused when the user interface receiver 102 asserts the UI_interrupt 118. Because this interrupt will be asserted each time a new code is received from the user interface 110, if the CPU 101 takes too long to respond, the system 100 will appear to be unresponsive to the user. In order to facilitate monitoring the time needed by the interrupt service routine, as shown in FIG. 1, in this embodiment the UI_interrupt 118 is also coupled to the watch dog timer 108. Provided that substantially the same result is achieved, the steps of the flowchart of FIG. 4 need not be in the exact order shown and need not be contiguous, that is, other steps can be intermediate. As shown in FIG. 4, resetting an unresponsive system according to this exemplary embodiment includes the following steps:

Step 400: Perform system 100 operations according to programs running on a CPU 101.

Step 402: Receive a UI_interrupt signal 118 meaning that a code has been received at the user interface receiver 102 from the user interface 110.

Step 404: Enable a watch dog timer 108 to begin counting upwards. The watch dog timer 108 begins counting after each code has been received by the user interface receiver 102.

Step 406: Has the UI_interrupt signal 118 been cleared automatically by the CPU 101 after finishing the interrupt service routine to process the received code? If yes, proceed to step 410; otherwise, proceed to step 408.

Step 408: Has the watch dog timer 108 reached a first predetermined timeout value (e.g., 1^{st} timeout 119)? This will be true if the CPU 101 does not perform the interrupt service routine to process the code received by the user interface receiver 102 before the watch dog timer 108 reaches the first predetermined timeout value 119. In this situation, proceed to step 412; otherwise return to step 404 to continue waiting.

Step 410: Because the CPU 101 processed the interrupt within an acceptable time (i.e., before the first timeout value 119 was reached by the watch dog timer 108), clear the watch dog timer 108 back to zero and return to step 400 to perform normal operations while waiting for the next code to be received at the user interface receiver 102.

Step 412: Does the user interface code received at step 402 equal a predetermined reset code? For example, if the predetermined reset code corresponds to the power button being pressed on the user interface 110, was the code corresponding to the power button received by user interface receiver 102? If yes, proceed to step 416; otherwise, proceed to step 414.

Step 414: Clear the interrupt from the user interface receiver 102 so that a next code can be received. For example, in FIG. 1, the UI_interrupt 118 will not be automatically cleared by the CPU 101 because the CPU 101 is no longer responding to interrupts. Therefore, during this step, the user interface receiver 102 will not only clear the UI_interrupt 118 and previously received code but also recover itself to enable a next code to be received from the user interface 110.

Step 416: After the predetermined reset code is received, the reset controller 106 asserts the reset signal 128 to restart the CPU 101 and typically the entire system 100. In this way, the watch dog timer 108 precisely detects when the system is in an unresponsive condition and allows the user to then recover from the unresponsive condition by performing a predetermined action at the user interface 110.

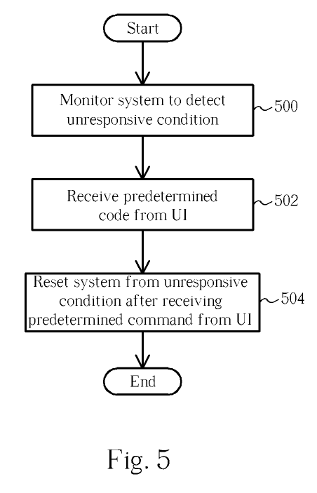

As will be apparent to a person of ordinary skill in the art after having read this disclosure, features of the embodiments shown in FIG. 2 and FIG. 3 may also be combined with the embodiment shown in FIG. 4, and vice versa. For example, similar to step 204 in FIG. 2, different definitions of the predetermined reset code can be applied to step 412 in FIG. 4. Additionally, the watch dog timer 108 can again be configured to automatically reset the system 100 after reaching the second timeout value 120 if the user has not yet manually reset the system 100 from the unresponsive condition. In general, FIG. 5 shows a more generalized method of resetting an unresponsive system according to a fourth exemplary embodiment. Provided that substantially the same result is achieved, the steps of the flowchart of FIG. 5 need not be in the exact order shown and need not be contiguous, that is, other steps can be intermediate. In this embodiment, resetting an unresponsive system includes the following steps:

Step 500: Monitor the system 100 to detect when the system 100 is in an unresponsive condition.

Step 502: Receive a predetermined code from a user interface 110.

Step 504: Reset the system 100 from the unresponsive condition after receiving the predetermined code from the user interface 110.

By providing a reset controller 106 being coupled to a user interface receiver 102 and a watch dog timer 108 for resetting the system 100 from an unresponsive condition after receiving a predetermined code from the user interface 110, a user of the system 100 remains in control of resetting the system 100 even when the system 100 is otherwise unresponsive. For example, the user will notice that the system 100 is not working properly and will perform a predetermined action on the user interface 110, such as pressing a power, a reset button, or other actions, to thereby manually reset the system 100 and regain control.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of resetting an unresponsive system, the method comprising:
monitoring the system to detect when the system is in an unresponsive condition;
receiving a predetermined code from a user interface; and
resetting the system from the unresponsive condition after receiving the predetermined code from the user interface.

2. The method of claim 1, further comprising monitoring a processing unit of the system to ensure the processing unit is servicing interrupts within a predetermined period of time; and determining the system to be in the unresponsive condition when the processing unit does not service an interrupt within the predetermined period of time.

3. The method of claim 1, further comprising waiting a predetermined delay time and then resetting the system from the unresponsive condition if the predetermined code has not yet been received from the user interface.

4. The method of claim 1, further comprising:
receiving a plurality of codes from the user interface;
comparing each code received with the predetermined code; and
resetting the system from the unresponsive condition if at least one of the codes
received from the user interface is the same as the predetermined code.

5. The method of claim 4, further comprising clearing a user interface interrupt after receiving each code from the user interface when the system is in the unresponsive condition so that further codes can be received from the user interface.

6. The method of claim 1, wherein the user interface corresponds to a remote control device for controlling the system from a location being a distance away from the system.

7. The method of claim 1, wherein the user interface is accessed through a network.

8. The method of claim 1, wherein the predetermined code corresponds to a predetermined button of the remote control being pressed.

9. The method of claim 1, wherein the predetermined code corresponds to a predetermined button of the remote control being pressed for a minimum time duration or for a minimum number of times.

10. The method of claim 1, wherein the predetermined code a predetermined sequence of buttons of the remote control being pressed.

11. The method of claim 1, further comprising:
receiving codes from a plurality of user interfaces; and
resetting the system from the unresponsive condition after receiving the predetermined code from at least one of the user interfaces.

12. The method of claim 1, wherein resetting the system from the unresponsive condition further comprises powering off the system.

13. A system being capable of recovering from an unresponsive condition, the system comprising:
a user interface receiver for receiving a predetermined code from a user interface; and
a reset unit being coupled to the user interface receiver for monitoring the system to detect when the system is in the unresponsive condition, and for resetting the system from the unresponsive condition after receiving the predetermined code from the user interface.

14. The system of claim 13, wherein the reset unit comprises:
a reset controller; and
a watch dog timer being coupled to the reset controller and a processing unit of the system for monitoring the processing unit to ensure the processing unit is servicing interrupts within a predetermined period of time; the watch dog timer determining the system to be in the unresponsive condition when the processing unit does not service an interrupt within the predetermined period of time.

15. The system of claim 14, wherein the watch dog timer is further for waiting a predetermined delay time and then sending a signal to the reset controller to reset the system from the unresponsive condition if the predetermined code has not yet been received from the user interface.

16. The system of claim 14, wherein the user interface receiver is further for receiving a plurality of codes from the user interface; and the system further comprises a code comparator being coupled to the user interface receiver for comparing each code received from the user interface with the predetermined code, and sending a signal to the reset controller to reset the system from the unresponsive condition if at least one of the codes received from the user interface is the same as the predetermined code.

17. The system of claim 16, wherein the code comparator is further for clearing a user interface receiver interrupt after receiving each code from the user interface when the system is in the unresponsive condition so that further codes can be received from the user interface.

18. The system of claim 13, wherein the user interface corresponds to a remote control device for controlling the system from a location being a distance away from the system.

19. The system of claim 13, wherein the user interface is accessed through a network.

20. The system of claim 13, wherein the predetermined code corresponds to a predetermined button of the user interface being pressed.

21. The system of claim 13, wherein the predetermined code corresponds to a predetermined button of the user interface being pressed for a minimum time duration or for a minimum number of times.

22. The system of claim 13, wherein the predetermined code corresponds to a predetermined sequence of buttons of the user interface being pressed.

23. The system of claim 14, further comprising a plurality of user interfaces; wherein the user interface receiver is further for receiving codes from the plurality of user interfaces, and sending a signal to the reset controller to reset the system from the unresponsive condition after receiving the predetermined code from at least one of the user interfaces.

24. The system of claim 14, wherein the reset controller is further for resetting the system from the unresponsive condition by powering off the system.

25. The system of claim 13, wherein the system is an audio or video storage, recovery, processing, playback, or display device.

26. The system of claim 13, wherein the system is a portable electronic device.

27. A method of resetting a system, the method comprising:
receiving a user interface interrupt from a user interface;
enabling a counter to begin incrementing a timer value; and
if the timer value has exceeded a predetermined value and a user interface code of the user interface interrupt corresponds to a predetermined code, asserting a reset signal to reset the system.

28. The method of claim 27, wherein if the timer value has exceeded the predetermined value but the user interface code does not correspond to the predetermined code, clearing the counter and clearing the user interface interrupt to thereby return the timer value to a starting value and allow a next user interface interrupt to occur.

29. The method of claim 27, wherein if the user interface interrupt is serviced before the timer value has exceeded, clearing the counter to thereby return the timer value to a starting value.

30. The method of claim 27, wherein the user interface corresponds to a remote control device for controlling the system from a location being a distance away from the system.

31. The method of claim 27, wherein the user interface is accessed through a network.

32. The method of claim 27, wherein the predetermined code corresponds to a predetermined button of the remote control being pressed.

33. The method of claim 32, wherein the predetermined code corresponds to a predetermined button of the remote control being pressed for a minimum time duration or for a minimum number of times.

34. The method of claim 32, wherein the predetermined code a predetermined sequence of buttons of the remote control being pressed.

35. The method of claim 27, wherein resetting the system from the unresponsive condition further comprises powering off the system.
